(19) United States
(12) Patent Application Publication
(10) Pub. No.: US 2004/0131422 A1
(43) Pub. Date: Jul. 8, 2004

(54) Fastening structure for connector

(75) Inventors: Yi-Cheng Yuan, Chu-Nan (TW); Yung-Chuan Tseng, Chu-Nan (TW)

Correspondence Address: BACON & THOMAS, PLLC, 625 SLATERS LANE, FOURTH FLOOR, ALEXANDRIA, VA, 22314

(73) Assignee: Coretronic Corporation, Chu-Nan (TW)

(21) Appl. No.: 10/731,137

(22) Filed: Dec. 10, 2003

(30) Foreign Application Priority Data
Jan. 3, 2003 (TW) 092200270

(51) Int. Cl. F16D 1/00

(52) U.S. Cl. 403/408.1

(57) ABSTRACT

A fastening structure of the invention includes a substrate, an inserting hole and a plurality of resilient sheets. The inserting hole is formed through the substrate for receiving the connector. The resilient sheets and an inner periphery of the inserting hole define an opening for receiving the connector. After the connector is placed in the opening, a free section of each resilient sheet deforms to engage with at least one indentation formed on an external periphery of the connector, thereby allowing easy screwing of a screw nut onto the connector.

### BACKGROUND OF THE INVENTION

1. Field of the Invention

The invention relates to a fastening structure, and more particularly a fastening structure for a connector.

2. Description of the Related Art

Referring to FIG. 1A and FIG. 1B, a conventional F-type connector is mounted in a TV set for receiving cable video signals. The connector 12 has a threaded section 121 for connecting a TV cable. The TV set has a substrate with an inserting hole 11. The connector 12 is inserted through the inserting hole 11, exposing the threaded section 121 out of the substrate. Then, a screw nut 13 is screwed onto the threaded section 121 to fasten the F type connector 12 to the substrate 10.

In order to easily assemble the connector 12, the inserting hole 11 has a diameter larger than the diameter of the threaded section 121. As a result, the connector 12 cannot be easily put in place while engaging the screw nut 13 without a fixing structure, which affects the assembly efficiency.

### SUMMARY OF THE INVENTION

One object of the invention is to provide a fastening structure for a connector, in which resilient sheets are mounted inside an inner periphery of an inserting hole for quick fastening of the connector.

Another object of the invention is to provide a fastening structure for a connector, which allows an easy assembly of a screw nut onto the connector to increase the assembly efficiency.

In order to achieve the above and other objectives, the fastening structure of the invention includes a substrate, an inserting hole and a plurality of resilient sheets. The inserting hole is formed through the substrate for receiving the connector. At least one indentation is formed at an external periphery of the connector. The resilient sheets are mounted at the inner periphery of the inserting hole. The resilient sheets may curve toward or in opposition to the connector. If the resilient sheets curve toward to the connector, fixtures can be further provided to help the connector inserting into the inserting hole. Once the connector reaches a predetermined position, the resilient sheets deform to engage with the indentations so that the connector is located in place to allow easy screwing of a screw nut onto the connector, thereby increasing the assembly efficiency.

To provide a further understanding of the invention, the following detailed description illustrates embodiments and examples of the invention, this detailed description being provided only for illustration of the invention.

### BRIEF DESCRIPTION OF THE DRAWINGS

FIG. 1A and FIG. 1B are schematic views of the assembly of a conventional F type connector.

FIG. 2A and FIG. 2B are schematic views of the assembly of a fastening structure according to a first embodiment of the invention.

FIG. 3 is a front view of an inserting hole according to a first embodiment of the invention.

FIG. 4A and FIG. 4B are another schematic views of the assembly of a fastening structure according to first embodiment of the invention.

FIG. 5 is a front view of an inserting hole according to a second embodiment of the invention.

FIG. 6 is a front view of an inserting hole according to a third embodiment of the invention.

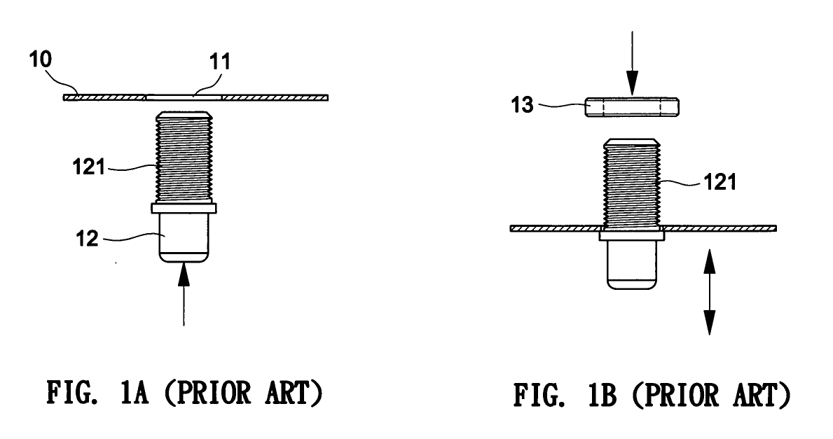

### DETAILED DESCRIPTION OF THE EMBODIMENTS

Wherever possible in the following description, like reference numerals will refer to like elements and parts unless otherwise illustrated.

### First Embodiment

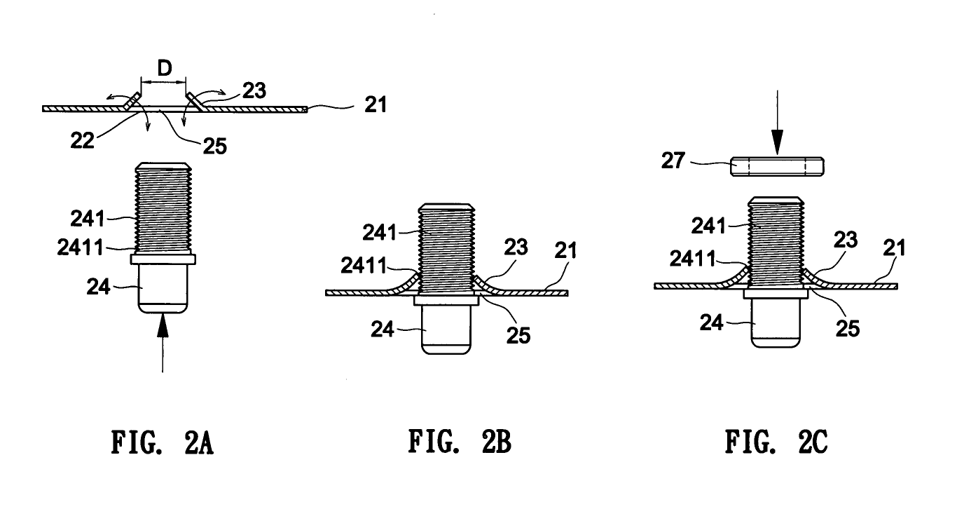

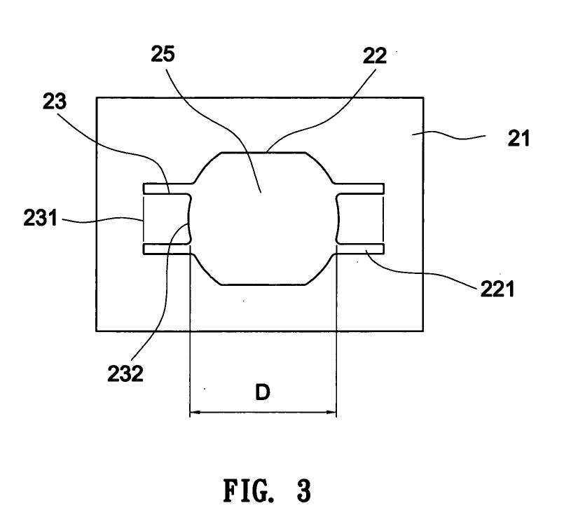

Referring to FIG. 2A and FIG. 2B, a fastening structure of the invention includes a substrate 21, an inserting hole 22, two resilient sheets 23 and a connector 24. Referring to FIG. 3, the inserting hole 22 is formed through the substrate 21. The inserting hole 22 has a polygonal shape and a plurality of recesses 221 in an inner wall. Each resilient sheet 23 has a contact end 231 and a curved free section 232 at a middle to form a “U” shape. The contact ends 231 are fixedly mounted at a bottom of one recess 221. The curved free section 232 and the periphery of the inserting hole 22 define an approximately round opening 25 for receiving the connector 24. The resilient sheet 23 may be integrally formed with the substrate 21 by punching. The connector 24 has a threaded section 241 in which indentations 2411 are formed between threads.

When a distance D between the curved free sections 232 of each resilient sheet 23 is in a range defined between the maximal diameter and the minimal diameter of the threaded section 241 of the connector 24, the assembly of the connector 24 is accomplished as shown in FIG. 2A and FIG. 2B. The connector inserts through the opening 25 from a backside of the substrate 21. The curved free section 232 curves opposite to the connector 24. The resilient sheet 23 is pushed outwardly by pushing the connector 24. The connector 24 can reach a predetermined position. Once the pushing force is released, the resilient sheet 23 rebounds to engage with the indentations 2411 of the connector 24 to easily fix the connector 24 on the substrate 21. In order to improve fastening of the connector, a screw nut 27 is screwed thereon from outside. Referring to FIG. 2C, when the connector 24 is fastened on the substrate 21 by engagement of the resilient sheets 23, the connector 24 is located in a position so that the screw nut 27 is easily screwed onto the connector 24 to increase the assembly efficiency.

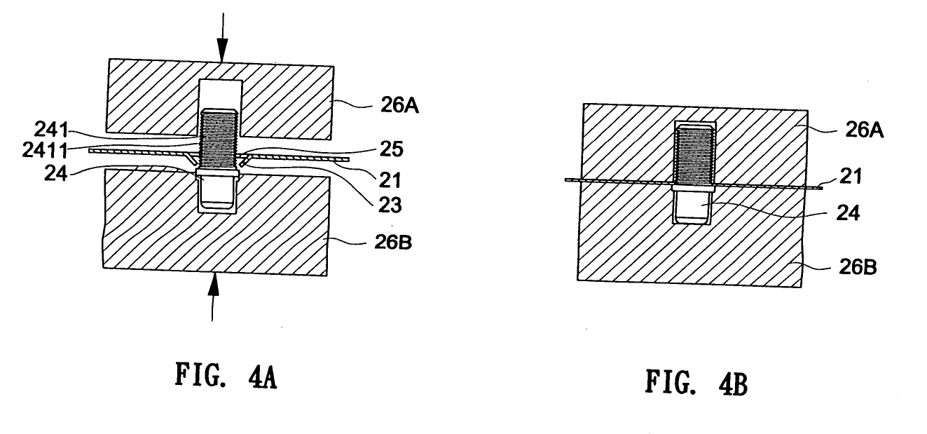

When the distance D between the curved free sections 232 is slightly larger than the maximal diameter of the threaded section 241, as shown in FIG. 4A and FIG. 4B, the connector 24 is inserted through the opening 25 from a backside of the substrate 21. The curved section 232 curves to the connector 24. Fixtures 26A, 26B are respectively mounted at either side of the substrate 21. When the fixtures 26A, 26B moves toward the substrate 21, the connector inserts into the opening 25. At the same time, the resilient sheets 23 are pushed to engage with the connector 24 so that the connector 24 is easily fastened onto the substrate 21 without the need of the nut 27.

### Second Embodiment

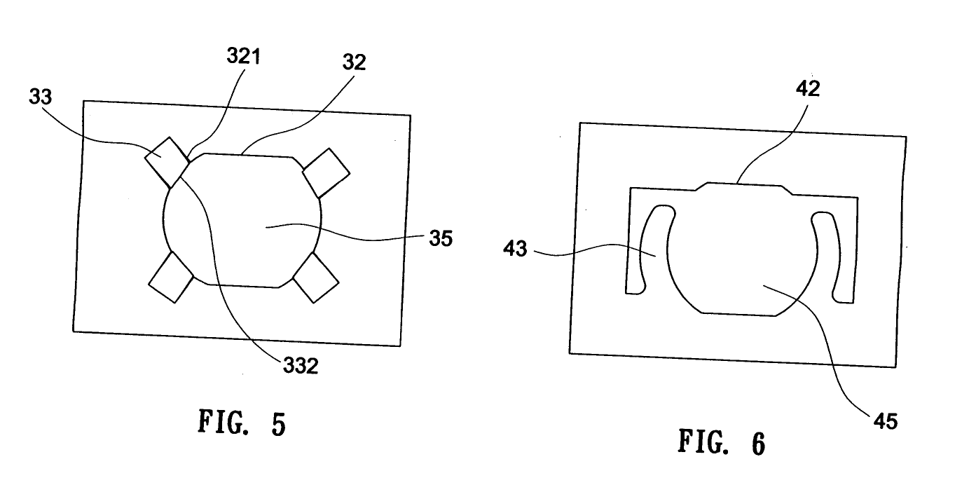

Referring to FIG. 5, this embodiment is very similar to the first embodiment, except that an inserting hole 32 has a polygonal cross-section taken in a radial direction, and resilient sheets 33 respectively have a rectangular shape fitting the recesses 321 that are formed at inner corners of the inserting hole 32. Each resilient sheet 33 has a contact end and a free section 332. The contact end is mounted at a bottom of the recess 321. The free section 332 and an inner periphery of the inserting hole 32 define an opening 35 for receiving the connector 24 with intensive support. The assembly of the connector 24 is accomplished in the same manner as the first embodiment.

### Third Embodiment

Referring to FIG. 6, this embodiment is very similar to the first embodiment, except that an inserting hole 42 has a polygonal cross-section in a radial direction, and resilient sheets 43 respectively have an arc shape. The resilient sheets 43 are mounted inside the inserting hole 42 so that arc edges of the resilient sheets 43 and an inner periphery of the inserting hole 42 define an arc opening 45 for receiving the connector 24. The assembly of the connector 24 is accomplished in the same manner as the first embodiment.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A fastening structure for a connector, comprising:
a substrate;
an inserting hole, formed through the substrate; and
a plurality of resilient sheets, formed along an inner periphery of the inserting hole, wherein each resilient sheet has a free section.

2. The fastening structure of claim 1, wherein the free section of the resilient sheet is a curved free section and has an angle between the free section and the substrate.

3. The fastening structure of claim 1, wherein the resilient sheet is integrally formed with the substrate.

4. The fastening structure of claim 1, wherein the inserting hole has a rectangular cross-section taken in a radial direction.

5. The fastening structure of claim 4, wherein the resilient sheets respectively have an arc shape and mounted inside the inserting hole so that arc edges of the resilient sheets and an inner periphery of the inserting hole define an arc opening.

6. The fastening structure of claim 1, wherein the inserting hole has a polygonal cross-section taken in a radial direction.

7. The fastening structure of claim 6, wherein one edge of each resilient sheet and the inner periphery of the inserting hole define an arc opening, while remaining portions of each resilient are located outside the inserting hole.

8. The fastening structure of claim 1, wherein the free sections curve in opposition to the connector.

9. The fastening structure of claim 8, wherein the distance between the free sections is slightly smaller than the diameter of the connector.

10. The fastening structure of claim 8, wherein the resilient sheet engages with at least one indentation of the connector.

11. The fastening structure of claim 1, wherein the resilient sheets curve toward the connector.

12. The fastening structure of claim 11, wherein the distance between the free sections is slightly larger than the diameter of the connector.

13. The fastening structure of claim 1, wherein the inserting hole has an approximately round hole.
